(19) United States
(12) Patent Application Publication
(10) Pub. No.: US 2026/0257739 A1
(43) Pub. Date: Sep. 3, 2026

(54) Bellows Assembly For An Articulated Bus

(71) Applicant: Carrosserie Hess AG, Bellach (CH)

(72) Inventors: Jan Wunderlich, Balsthal (CH); Alex Naef, Bellach (CH)

(73) Assignee: Carrosserie Hess AG, Bellach (CH)

(21) Appl. No.: 18/868,375

(22) PCT Filed: May 31, 2023
(86) PCT No.: PCT/EP2023/064579

§ 371 Date: Nov. 22, 2024

(30) Foreign Application Priority Data
May 31, 2022 (CH) CH000661/2022

(51) Int. Cl. B62D 47/02; B60Q 3/20

(52) U.S. Cl. CPC B62D 47/025; B60Q 3/20

(57) ABSTRACT

A bellows arrangement for an articulated bus, in particular a double-articulated bus, includes an inner bellows with a substantially U-shaped cross-section and an outer bellows with a substantially U-shaped cross-section, which surrounds the inner bellows, the inner bellows having a first translucent area and the outer bellows having a second translucent area.

### TECHNICAL FIELD

The invention relates to a bellows arrangement for an articulated bus and an articulated bus, in particular a double-articulated bus, with such a bellows arrangement.

### PRIOR ART

Bellows arrangements, which belong to the technical field initially mentioned, are known. Such bellows arrangements are arranged between two successive vehicle parts in articulated buses and double-articulated buses. The two vehicle parts are connected to each other by a joint with a vertical pivot axis, with a platform for passengers being arranged above the joint, which enables people to move from one vehicle part to the other. Typically, the bellows arrangement is arranged above this passage to protect the passage. An example of such a bellows arrangement is described in WO 91/02672 A1 of Hübner Gummi und Kunststoff GmbH.

The disadvantage of such known bellows arrangements is that they only allow for poor thermal insulation. Accordingly, unpleasantly warm temperatures can arise inside an articulated bus or double-articulated bus in summer and unpleasantly cold temperatures in winter, or the articulated bus or double-articulated bus has to be equipped with a disproportionately dimensioned heating and air conditioning system to counteract the poor thermal insulation. However, such strong air conditioning leads to an unpleasant feeling for passengers in the area of the platform inside such bellows arrangements, just as if the air conditioning is inadequate and unpleasantly warm temperatures arise in summer or unpleasantly cold temperatures in winter.

In the present text, the terms “below” and “above” as well as “lengthwise direction” and “bellows main plane” are used with regard to the bellows arrangement. These terms refer to the orientation of the bellows arrangement when the bellows arrangement is located in the area of a joint between two consecutive vehicle parts of an articulated or double-articulated bus and surrounds a platform for passengers, protecting them from environmental influences. In this case, the “lengthwise direction” of the bellows arrangement corresponds to the lengthwise alignment of the articulated bus or double-articulated bus when the two vehicle parts between which the bellows arrangement is arranged are not tilted in relation to one another but are arranged along a straight line. Furthermore, the “bellows main plane” corresponds to the plane that is perpendicular to the “lengthwise direction” of the bellows arrangement. In addition, in this reference system, the inner bellows and the outer bellows have a “first end” and a “second end”, between which the inner bellows and the outer bellows extend in the “lengthwise direction”.

### DESCRIPTION OF THE INVENTION

The object of the invention is to provide a bellows arrangement for an articulated bus, in particular a double-articulated bus, which belongs to the technical field initially mentioned and which increases comfort for the passengers of the articulated bus or double-articulated bus in the area of the bellows arrangement.

The solution to the object is defined by the features of claim 1. According to the invention, the bellows arrangement comprises an inner bellows with a substantially U-shaped cross-section and an outer bellows with a substantially U-shaped cross-section, which outer bellows surrounds the inner bellows.

The bellows arrangement according to the invention is suitable for articulated buses with one or more articulations, in particular also for double-articulated buses. In such an articulated bus or double-articulated bus, the bellows arrangement is arranged in the area of a joint between two successive vehicle parts of the articulated bus or double-articulated bus and generally surrounds a platform for passengers, protecting them from environmental influences. The bellows arrangement is preferably arranged in such a way that the essentially U-shaped cross-section of the inner bellows and the essentially U-shaped cross-section of the outer bellows are aligned as an inverted U and therefore form vertical sides or side walls and a roof section arranged between them with their three legs. Together with the platform for passengers, which forms a floor, the bellows arrangement thus forms a tube-like passageway through which the two successive vehicle parts for the articulated bus or double-articulated bus are connected to one another for the passengers.

In order for the bellows arrangement to be suitable for articulated buses, the bellows arrangement preferably allows the two consecutive vehicle parts, between which the bellows arrangement is arranged, to be angled sideways up to an angle of 30° or more between the consecutive vehicle parts. For this purpose, the bellows arrangement, when the successive vehicle parts are arranged in parallel, preferably has a length of about 1.5 m to about 4 m, in particular 1.5 m to 2 m, measured in the lengthwise direction.

In the bellows arrangement, the inner bellows and the outer bellows are preferably arranged in such a way that the outer bellows encloses the inner bellows along its three legs, i.e. on the left vertical side, the roof section and the right vertical side.

Due to the double-walled arrangement with the inner bellows and the outer bellows, the thermal insulation in the area of the bellows arrangement or in the joint area of the articulated bus or double-articulated bus with the bellows arrangement according to the invention is significantly better than in the case of known single-walled solutions. As a result, a less powerful vehicle air conditioning system is sufficient to achieve pleasant temperatures inside the vehicle. The less powerful vehicle air conditioning system, which nevertheless achieves more pleasant temperatures inside the vehicle, increases the comfort for the passengers of the articulated bus or double-articulated bus in the area of the bellows arrangement.

Advantageously, the inner bellows has a first translucent area and the outer bellows has a second translucent area, with the first translucent area and the second translucent area being aligned with each other.

In the present case, an area is considered to be “translucent” if it has a transmission factor that is at least four times higher in the wavelength range from 280 nm to 800 nm, in particular from 400 nm to 700 nm, compared to the other areas of the respective bellows. In particular, the transmission factor in this wavelength range is at least 50%.

The fact that the translucent areas of the inner bellows and the outer bellows are aligned with each other preferably means that they at least partially overlap, so that light from outside the bellows arrangement can pass directly through the two translucent areas into the interior of the bellows arrangement inside the inner bellows.

In that the inner bellows has a first translucent area and the outer bellows has a second translucent area, with the first translucent area and the second translucent area being aligned with one another, the advantage is achieved that, on the one hand, improved thermal insulation can be achieved inside an articulated bus or double-articulated bus due to the inner bellows and the outer bellows, and, on the other hand, light from outside the articulated bus can pass through the bellows arrangement into the bellows arrangement when a bellows arrangement is installed in an articulated bus. Both these factors together increase the driving comfort for the passengers of the articulated or double-articulated bus in the area of the bellows arrangement.

Advantageously, in a straight configuration of the bellows assembly, the outer bellows is spaced from the inner bellows. In the straight configuration of the bellows assembly, the two consecutive vehicle parts between which the bellows assembly is arranged are preferably aligned along the same straight line, i.e. the two consecutive vehicle parts between which the bellows arrangement is located are preferably not angled towards each other or have an angle of 0° towards each other, respectively.

It is not necessary for the distance between the two bellows to be constant. In particular, the distance in a lower area, adjacent to the platform for passengers, can be increased by pulling the inner bellows downwards inwards towards the outer edge of the platform.

In that the outer bellows is spaced from the inner bellows in the straight configuration of the bellows arrangement, the advantage is achieved that the bellows arrangement can optimally adapt to the tilting of the two vehicle parts between which the bellows arrangement is arranged when the articulated bus or double-articulated bus comprising the bellows arrangement drives through curves. When curving in this way, the folds of the inner bellows and the outer bellows may also touch each other temporarily.

Alternatively, it is also possible that, when the bellows arrangement is in the straight configuration, the outer bellows touches the inner bellows at least at one point.

The first translucent area and the second translucent area are preferably located in the two vertical sides of the inner bellows and the outer bellows. This has the advantage that the first translucent area and the second translucent area in the bellows arrangement can create the impression of a side window.

Advantageously, the first translucent area and the second translucent area extend between a first height and a second height, while the vertical sides of the inner bellows and the outer bellows are non-translucent below the first height and above the second height.

In the present text, “not translucent” means “opaque”, or that the degree of transmission in the wavelength range from 280 nm to 800 nm, in particular from 400 nm to 700 nm, is reduced by at least four times that of the “translucent” areas. Preferably, “non-translucent” or “opaque” means that in the wavelength range from 280 nm to 800 nm, in particular from 400 nm to 700 nm, the degree of transmission is at most 5%, particularly preferably at most 1%.

In a particularly preferred variant, the translucent areas are dimensioned and positioned to correspond to the window arrangement in the neighboring vehicle parts between which the bellows arrangement is located. This not only results in a uniform appearance from the inside and outside, but also provides a clear height reference point for the passengers in the interior, which facilitates orientation and ultimately improves safety in the interior.

In one variant of this, the vertical sides of the inner bellows and the outer bellows are not translucent only below the first height, only above the second height, or neither below the first height nor above the second height.

As an alternative to these variants, it is also possible for the first translucent area and the second translucent area to be located only in one of the two vertical sides of the inner bellows and the outer bellows or only in the roof section of the inner bellows and the outer bellows.

The advantage of this is that the roof section of the inner bellows and the outer bellows are not translucent. This has the advantage of creating a sense of a roof for the passengers in the interior.

Alternatively, the roof section of the inner bellows and the outer bellows may also have at least one translucent area.

Advantageously, the inner bellows and the outer bellows are connected to a first common end profile at a first end and to a second common end profile at a second end. This has the advantage that the bellows arrangement has greater inherent stability and at the same time can be more easily attached between two consecutive vehicle parts of the articulated or double-articulated bus. The end profiles thus form bellows carrier plates. They are used to attach the bellows arrangement to the neighboring vehicle parts between which the bellows arrangement is or is to be arranged.

The end profiles and the outer bellows are advantageously dimensioned so that in cross-section, the outer bellows does not extend beyond the end profiles. This has the advantage that the articulated bus or double-articulated bus does not have a greater width in the area of the bellows arrangement than the two vehicle parts between which the bellows arrangement is located. However, it is also possible to dimension the end profiles and the outer bellows in such a way that in the cross-section, the outer bellows protrudes beyond the end profiles, at least in places.

In one variant, the inner bellows and the outer bellows are only connected to a first common end profile at a first end and are not connected to a second common end profile at a second end.

Alternatively, it is also possible that the inner bellows and the outer bellows in the lengthwise direction of the bellows arrangement are neither connected to a common end profile at the first end nor the second end.

If the inner bellows and the outer bellows are connected to a first common end profile at a first end and to a second common end profile at a second end, then the inner bellows is preferably composed of a first longitudinal section and a second longitudinal section and the outer bellows is preferably composed of a third longitudinal and a fourth longitudinal section, wherein the first longitudinal section and the third longitudinal section are attached at one end to the first end profile and at an opposite end to a center profile, and wherein the second longitudinal section and the fourth longitudinal section are attached at one end to the second end profile and at an opposite end to the center profile.

The center profile is preferably attached to the joint of the articulated bus or to one of the joints of the double-articulated bus, thus ensuring that the bellows arrangement deforms as desired when curving, essentially along an arc.

The center profile, the outer bellows and the end profiles are advantageously dimensioned so that in cross-section, the outer bellows and the center profile do not protrude beyond the end profiles. This has the advantage that the articulated bus or double-articulated bus does not have a greater width in the area of the bellows arrangement than the two vehicle parts between which the bellows arrangement is located. However, it is also possible to dimension the center profile, the outer bellows and the end profiles in such a way that in cross-section, the outer bellows and/or the center profile extend beyond the end profiles, at least in places.

A lighting device, in particular an LED light strip, is preferably arranged on the center profile, which extends along the center profile, in particular in the interior of the bellows arrangement in the interior of the inner bellows.

The LED strip is particular preferably extended along the entire center profile, i.e. from the left vertical side over the roof section to the right vertical side. This has the advantage that the center profile and thus the center of the bellows arrangement is clearly visible. This facilitates orientation and thus also an evacuation of the articulated bus or double-articulated bus in poor visibility conditions, for example, if smoke develops inside the articulated bus or double-articulated bus. Accordingly, this increases safety for the passengers of the articulated bus or double-articulated bus.

In one variant of this, there is no lighting device arranged on the center profile, which extends along the center profile, in particular in the interior of the bellows arrangement in the interior of the inner bellows.

Alternatively to these variants, the bellows arrangement can also be designed without a center profile.

Advantageously, the outer bellows is made of a silicone material reinforced with aramid fibers, at least in sections outside the second translucent area. This has the advantage that the safety during the operation of an articulated or double-articulated bus is increased with the bellows arrangement, since the silicone material reinforced with aramid fibers has fire-retardant properties.

The three-layer silicone material reinforced with aramid fibers is particularly preferred. Preferably, this is a layer of aramid fibers, in particular a fabric of aramid fibers, which is coated on both sides with silicone.

In a variant, the aramid-fiber-reinforced silicone material can also be constructed differently.

As an alternative to these variants, the outer bellows is not made of a silicone material reinforced with aramid fibers at least in sections outside the second translucent area.

Advantageously, the first translucent area and the second translucent area are made of a two-layer material. This has the advantage that the first translucent area and the second translucent area are more stable.

Advantageously, the first translucent area and the second translucent area are made of a polyester fabric, in particular a two-layer polyester fabric. This has the advantage that the first translucent area and the second translucent area are particularly durable when the bellows arrangement is in operation and can withstand a particularly large number of bending movements, which occur when an articulated or double-articulated bus travels around a bend with the bellows arrangement, with only the slightest wear.

Alternatively, however, it is also possible that the first translucent area and the second translucent area are made of a two-layer material, but not of a polyester fabric, that neither the first translucent area nor the second translucent translucent area are made of a two-layer material, but are made of a polyester fabric, or that the first translucent area and the second translucent area are not made of a two-layer material and are also not made of a polyester fabric.

Advantageously, the inner bellows is made of a polyester fabric, in particular a single-layer polyester fabric, at least in sections outside the first translucent area.

Alternatively, however, it is also possible that the inner bellows is not made of a single-layer polyester fabric or is not made of a polyester fabric at all at least in sections outside the first translucent area.

Preferably, the articulated bus, in particular a double-articulated bus, has a bellows arrangement according to the invention.

The following detailed description and the entirety of the patent claims reveal further advantageous embodiments and feature combinations of the invention.

### BRIEF DESCRIPTION OF THE DRAWINGS

The drawings used to explain the embodiment show:

FIG. 1 an angled view of a bellows arrangement according to the invention for articulated buses with one or more articulations, in particular also for double-articulated buses, and

FIG. 2 a representation of a cross-section running horizontally through the bellows arrangement, viewed from above onto the cross-section.

In principle, the same reference symbols are used for the same parts in the figures.

### WAYS TO REALIZE THE INVENTION

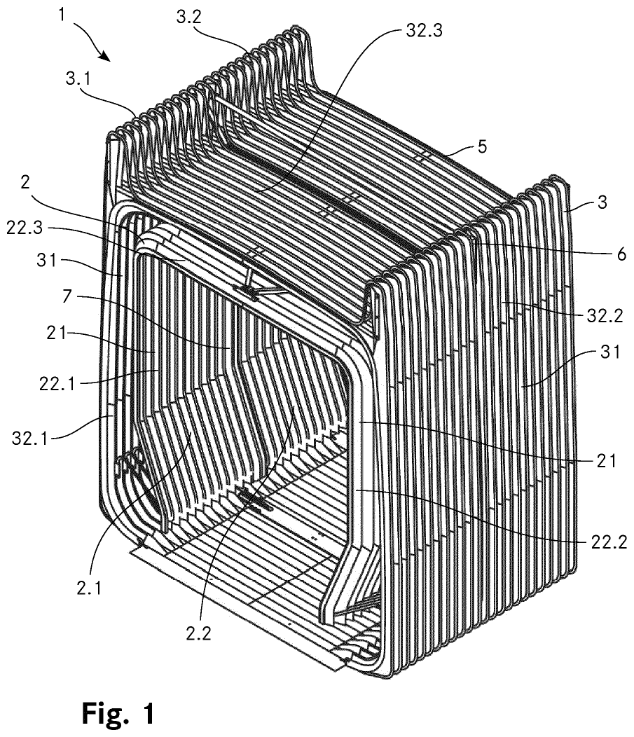

FIG. 1 shows an oblique view of a bellows arrangement 1 for articulated buses with one or more articulations, in particular also for double-articulated buses, according to the invention. In the representation of FIG. 1, the lengthwise direction of the bellows arrangement 1 runs from bottom left to top right. In FIG. 1, the top and bottom of the bellows arrangement 1 are at the bottom and top of the figure.

The bellows arrangement 1 comprises an inner bellows 2 with a substantially U-shaped cross-section and an outer bellows 3 with a substantially U-shaped cross-section, which outer bellows 3 surrounds the inner bellows 2. When the bellows arrangement 1 is installed in an articulated bus or double-articulated bus, the bellows arrangement 1 is arranged in the area of a joint between two consecutive vehicle parts of the articulated bus or double-articulated bus and generally surrounds a platform for passengers and protects them from environmental influences. In this case, the bellows arrangement 1 is aligned as shown in FIG. 1 in such a way that the essentially U-shaped cross-section of the inner bellows 2 and the essentially U-shaped cross-section of the outer bellows 3 are aligned as an inverted U and therefore form with their three legs, vertical sides 22.1, 22.2, 32.1, 32.2 or side walls and a roof section 22.3, 32.3 arranged between them. The inner bellows 2 and the outer bellows 3 are arranged in such a way that the outer bellows 3 encloses the inner bellows 2 along its three sides, i.e. on the left vertical side 22.1, 32.1, the roof section 22.3, 32.3 and the right vertical side 22.2, 32.2. Together with the platform for passengers, which forms a floor, the bellows arrangement 1 thus forms a tube-like passageway through which the two successive vehicle parts are connected to one another for the passengers of the articulated or double-articulated bus.

If the bellows arrangement 1 is in a straight configuration as shown in FIG. 1, the outer bellows 3 is spaced from the inner bellows 2. In this straight configuration of the bellows arrangement 1, the two successive vehicle parts between which the bellows arrangement 1 is arranged are aligned along the same straight line, i.e. the two successive vehicle parts between which the bellows arrangement 1 is arranged are not angled towards each other or have an angle of 0° towards each other, respectively.

Apart from the straight configuration, the bellows arrangement 1 allows the two consecutive vehicle parts, between which the bellows arrangement 1 is arranged, to be angled sideways up to an angle of 30° or more between the two consecutive vehicle parts. For this purpose, the bellows arrangement 1 has a length of about 1.75 m when measured in the lengthwise direction in the straight configuration, i.e. when the successive vehicle parts are arranged parallel to one another. However, this length can also be shorter or longer. For example, the length can be 1.5 m, 2 m, 3 m or 4 m.

The inner bellows 2 has a first translucent area 21 and the outer bellows 3 has a second translucent area 31, with the first translucent area 21 and the second translucent area 31 being aligned with one another. Thereby, the first translucent area 21 and the second translucent area 31 have at least four times the transmission in the wavelength range from 400 nm to 700 nm compared to the other areas of the respective bellows 2, 3. In one variant of this, the first translucent area 21 and the second translucent area 31 have at least four times the transmission in the wavelength range from 280 nm to 800 nm compared to the other areas of the respective bellows 2, 3.

The first translucent area 21 and the second translucent area 31 are located in the two vertical sides 22.1, 22.2, 32.1, 32.2 of the inner bellows 2 and the outer bellows 3. The first translucent area 21 and the second translucent area 31 extend between a first height and a second height, while the vertical sides 22.1, 22.2, 32.1, 32.2 of the inner bellows 2 and of the outer bellows 3 are non-translucent below the first height and above the second height and have a transmittance of less than 1% in the wavelength range from 400 nm to 700 nm. In a variant thereof, the vertical sides 22.1, 22.2, 32.1, 32.2 of the inner bellows 2 and the outer bellows 3 are not translucent below the first height and above the second height and have a transmittance of less than 1% in the wavelength range from 280 nm to 800 nm.

Strictly speaking, the translucent areas 21, 31 are dimensioned and positioned so that they correspond to the window arrangement in the neighboring vehicle parts, between which the bellows arrangement 1 is arranged. As can be seen in FIG. 1, the translucent areas 21, 31 of the inner bellows 21 and the outer bellows 31 therefore overlap and are thus aligned with each other, so that light from outside the bellows arrangement 1 can pass directly through the two translucent areas 21, 31 into the interior of the bellows arrangement 1 in the interior of the inner bellows 2.

In the present example, the roof section 22.3, 32.3 of the inner bellows 2 and the outer bellows 3 is not translucent. In variants to this, however, it is also possible that the roof section 22.3, 32.3 of the inner bellows 2 and the outer bellows 3 has a translucent area or is entirely translucent.

The outer bellows 3 is made of a silicone material reinforced with aramid fibers in the sections outside the second translucent area 31. The aramid-fiber-reinforced silicone material is three-layered. It is a fabric made of aramid fibers coated on both sides with silicone. The inner bellows 2, on the other hand, is made of a single-layer polyester fabric in the sections outside of the first translucent area 21. Furthermore, the first translucent area 21 and the second translucent area 31 are made of a two-layer polyester fabric and thus of a two-layer material. In variants of this, the outer bellows 3 in the sections outside the second translucent area 31, the inner bellows 2 in the sections outside the first translucent area 21, and the first translucent area 21 and the second translucent area 31 can also be made of materials other than those mentioned above.

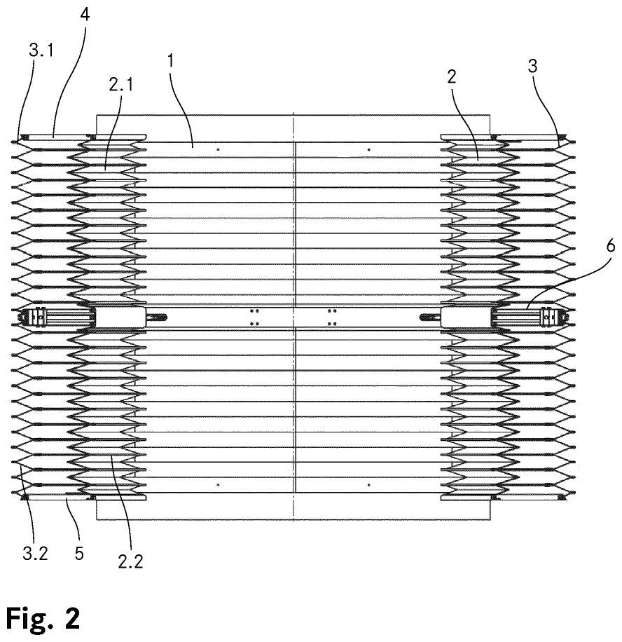

FIG. 2 shows a cross-section running horizontally through the bellows arrangement 1, viewed from above onto the cross-section.

As can be seen in FIG. 2, the inner bellows 2 and the outer bellows 3 are connected at a first end to a first common end profile 4 and at a second end to a second common end profile 5. In the illustration of FIG. 1, only the second common end profile 5 facing away from the observer is shown of these two end profiles 4, 5. In FIG. 1, only the upper edge of this second common end profile 5 can be seen. The first common end profile 4, which is arranged at the first end of the inner bellows 2 and the outer bellows 3 facing the observer, is not shown in the representation in FIG. 1 so that it can be seen how the outer bellows 3 surrounds the inner bellows 2 and that there is a distance between the inner bellows 2 and the outer bellows 3.

As can be seen in both FIG. 2 and FIG. 1, the inner bellows 2 is composed of a first longitudinal section 2.1 and a second longitudinal section 2.2, and the outer bellows 3 is composed of a third longitudinal section 3.1 and a fourth longitudinal section 3.2. As can be seen in FIG. 2, the first longitudinal section 2.1 and the third longitudinal section 3.1 are attached at one end to the first end profile 4 and at an opposite end to a center profile 6, while the second longitudinal section 2.2 and the fourth longitudinal section 3.2 are attached at one end to the second end profile 5 and at an opposite end to the center profile 6. The center profile 6, the outer bellows 3 and the end profiles 4, 5 are dimensioned so that the outer bellows 3 and the center profile 6 do not extend beyond the end profiles 4, 5 in cross-section.

As can be seen in FIG. 1, an LED light band 7 is arranged on the center profile 6 as a lighting device, which extends in the interior of the bellows arrangement 1 in the interior of the inner bellows 2 along the center profile 6. This LED light strip extends essentially along the entire center profile 6, i.e. from the left vertical side 22.1 over the roof section 22.3 to the right vertical side 22.2.

The invention is not limited to the embodiments explained in connection with the figures. Rather, the description directly reveals further variants and embodiments falling within the scope of the protection claimed in the claims to a person skilled in the art.

In summary, it can be stated that a bellows arrangement is provided for an articulated bus, in particular a double-articulated bus, by means of which the comfort for the passengers of the articulated bus or double-articulated bus is increased in the area of the bellows arrangement.

1. A bellows arrangement for an articulated bus, comprising
a) an inner bellows with a substantially U-shaped cross-section; and
b) an outer bellows with a substantially U-shaped cross-section, wherein the outer bellows surrounds the inner bellows
wherein the inner bellows has a first translucent area and the outer bellows has a second translucent area, and
wherein the first translucent area and the second translucent area are aligned with each other.

2. (canceled)

3. The bellows arrangement according to claim 1, wherein, in a straight configuration of the bellows arrangement, the outer bellows is spaced apart from the inner bellows.

4. The bellows arrangement according to claim 1, wherein the first translucent region and the second translucent region are located in both vertical sides of the inner bellows and of the outer bellows.

5. The bellows arrangement according to claim 4, wherein the first translucent area and the second translucent area extend between a first height and a second height, while the vertical sides of the inner bellows and of the outer bellows are non-translucent below the first height and above the second height.

6. The bellows arrangement according to claim 4, wherein roof portion of the inner bellows and the outer bellows are not translucent.

7. The bellows arrangement according to claim 1, wherein the inner bellows and the outer bellows are connected at a first end to a first common end profile and at a second end to a second common end profile.

8. The bellows arrangement according to claim 7, wherein the inner bellows comprises a first longitudinal section and of a second longitudinal section, and wherein the outer bellows comprises a third longitudinal section and a fourth longitudinal section, the first longitudinal section and the third longitudinal section are attached at one end to the first end profile and at an opposite end to a center profile, and the second longitudinal section and the fourth longitudinal section are attached at one end to the second end profile and at an opposite end to the center profile.

9. The bellows arrangement according to claim 8, wherein a lighting device is arranged on the center profile and extends along the center profile.

10. The bellows arrangement according to claim 1, wherein the outer bellows is made, at least in sections outside the second translucent area, of a silicone material reinforced with aramid fibers.

11. An articulated bus having a bellows arrangement for an articulated bus, the bellows arrangement comprising
a) an inner bellows with a substantially U-shaped cross-section; and
b) an outer bellows with a substantially U-shaped cross-section, wherein the outer bellows surrounds the inner bellows,
wherein the inner bellows has a first translucent area and the outer bellows has a second translucent area, and
wherein the first translucent area and the second translucent area are aligned with each other.

12. The bellows arrangement according to claim 9, wherein the lighting device extends along the center profile in the interior of the bellows arrangement in the interior of the inner bellows.

13. The bellows arrangement according to claim 9, wherein the lighting device is an LED light band.

14. The articulated bus according to claim 11, wherein the articulated bus is a double-articulated bus.
